(19) United States
(12) Patent Application Publication
(10) Pub. No.: US 2008/0109241 A1
(43) Pub. Date: May 8, 2008

(54) Method, System and Computer Program For Metering Usage of Software Products With a Dynamically Optimised License Use

(76) Inventors: Salvatore D'Alo, Roma (IT); Salvatore D'Angelo, Matteotti (IT); Mario Noioso, Roma (IT); Bernardo Pastorelli, L'Aquila (IT); Antonio Perrone, Roma (IT); Roberto Piras, Roma (IT); Riccardo Rossi, Roma (IT); Gianluca Seghetti, Roma (IT)

Correspondence Address: IBM CORPORATION;INTELLECTUAL PROPERTY LAW, 11400 BURNET ROAD, AUSTIN, TX, 78758, US

(21) Appl. No.: 11/931,054

(22) Filed: Oct. 31, 2007

(30) Foreign Application Priority Data
Nov. 2, 2006 (EP) 06123333.4

(51) Int. Cl. G06Q 10/00; G06F 17/40; G06F 19/00

(52) U.S. Cl. 705/1

(57) ABSTRACT

A solution for metering usage of at least one software product on a data processing system, the at least one software product having a plurality of available associated licenses, each license having a set of attributes. An event indicative of the use of the at least one product on the system is detected. Responsive to the detection, the best available license among said plurality of licenses is determined according to predetermined preference rules of the attributes. Metering conditions to the at least one software product are applied according to the identified best available license. A change of the best available license is detected. New metering conditions are applied to the at least one software product accordingly.

### TECHNICAL FIELD

The present invention relates to the data processing field. More specifically, the present invention relates to a method of controlling and metering usage of software products on a data processing system. The invention further relates to a computer program for performing the method, and to a product embodying the program. Moreover, the invention also relates to a corresponding apparatus.

### BACKGROUND ART

Software products (such as computer programs) can be perfectly reproduced in an infinite number of copies. This is a major concern for publishers of the products wishing to protect their intellectual property rights; indeed, the publishers typically receive a royalty for a licensed use of each product, so that any unaccounted use or distribution of the product results in unpaid royalties. The problem has been exacerbated in the last years by the widespread diffusion of the Internet, which further facilitates the uncontrolled distribution of this kind of products.

The most straightforward way of avoiding unaccounted usage of the products is that of preventing unauthorised copying and transmission. For example, some products embed control code that limits the number of copies that can be made or disables operation of the products after a predetermined period of time has lapsed. Another technique consists of requiring possession of a software or hardware key for running the products. A different solution consists of modifying each product to include a call to a licensing management system. Every time the product is started, a corresponding request is transferred to the licensing management system. The licensing management system verifies whether the usage of the product is authorised. If the result of the verification is positive, the product can continue its execution; otherwise, the product is forced to stop.

However, the technique described above requires each product to be modified by the publisher, so that they are not of general applicability. In addition, the solutions known in the art are quite rigid and cannot be readily adapted to different requirements.

A different approach is based on the use of a software catalogue. The software catalogue lists all the known products to be metered; each product is identified by one or more executable modules indicative of its running. In this case, a licensing agent working in the background detects the executable modules that have been launched; the licensing agent then identifies the corresponding products through the software catalogue.

For this purpose, the licensing agent periodically collects a list of the executable modules that are currently running. For each executable module, if the corresponding product is not authorised the licensing agent may kill the respective process (so as to stop execution of the product), and may make the product unable to start again. Alternatively, as described in WO-A-03038570, the licensing agent detects any new process that is started in response to the request of execution of a product (for example, using a kernel hooking technique). The process is suspended and an authorisation to run the product is verified. If the authorisation is granted, the process is resumed so as to enable the product to start. Conversely, the process is aborted thereby preventing execution of the product; this avoids killing the product while it is performing potentially risky operations.

It could happen with the techniques based on the software catalogue that several licenses might be available on the catalogue for the same product. When a request is received by the server and different versions of the same product are available and suitable for that request, the server should have an efficient mechanism to choose which of the several licenses is to be granted. Such an optimisation mechanism is very helpful for maximising the exploitation of the available licenses in term of use and consumption.

U.S. patent application Ser. No. 11/181,404 discloses a method and system for selecting the best license in order to maximise the exploitation of the available licenses. The proposed solution in the above cited prior art is based on the idea that, if a choice is possible, it is preferable to use a license with a narrower scope, leaving a license with a wider applicability for future needs. Licenses are stored on a catalogue with an associated list of parameters indicative of usage constraints of the product. The licenses are then ordered according to predetermined parameters optimisation criteria, so that when a request is received, the license manager can easily find the best license, i.e. that license, suitable for the requested use, having the highest usage constraint.

However, organisations are every day more complex and they tend to be organised in more complex way with respect to the traditional geographical organisation. On the other hand hardware virtualisation technology is always evolving, providing increasing flexibility and complexity in the hardware partition alternatives.

To increase revenues and provide tailored offering to different customers, license terms and conditions are every day more complex ranging from licenses which can be used without limitations by the whole enterprise and paid as soon as the license is acquired to licenses target to a single operating system whose fee is based on how much the software is used and how powerful the system is.

Customers usually expect a licensing system to optimise license usage by associating to each software usage the license which allows to reduce the amount billed or to reduce future software upgrade and maintenance costs. Finding the best solution to the license allocation problem is an extremely complex task and very consuming in terms of Hardware computation resources. For this reason approximated solutions are often required.

So a licensing system is confronted to the problem of:

1. handling more and more complex organisations and virtualisation hierarchies;
2. providing the best license allocation.

Normally commercially available methods declare a software use as unlicensed when no license can be associated to a consume session (being it of installation or usage) based on targets defined for the license. This doesn't account for the source of the constraints, i.e. defined by the software vendor (like a license valid only for an hardware) or by the customer because of internal accounting.

It is an object of the present invention to provide a method and a system which alleviates the above drawbacks.

### SUMMARY OF THE INVENTION

According to the present invention we provide a method of metering usage of at least one software product on a data processing system, the at least one software product having a plurality of available associated licenses, each license having a set of attributes, the method including the steps of: detecting an event indicative of the use of the at least one product on the system, and responsive to the detection, determining the best available license among said plurality of licenses, according to predetermined preference rules of the attributes, applying metering conditions to the at least one software product according to the identified best available license; detecting a change of the best available license and applying new metering conditions to the at least one software product accordingly.

In this way, the exploitation of the available licenses is dynamically adjusted according to the modified conditioned of the system and of the availability of the licenses. When several licenses are available and suitable for the current needs, the conditions of the system are continuously monitored to determine which license is the best according to predefined parameters.

A further aspect of the present invention provides a computer program for performing the above-described method.

Moreover, another aspect of the invention provides a corresponding apparatus for metering usage of software products.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a schematic block diagram of a data processing system in which the method of the invention is applicable;

FIG. 1b shows the functional blocks of a generic computer of the system;

FIG. 2 depicts the main software components that can be used for practicing the method;

FIG. 3 show a diagram describing the order of visit of the virtualisation and organisational and geographical hierarchies used to assign licenses constraints; and

FIG. 4 shows a diagram describing the flow of activities relating to an illustrative implementation of the method.

### DETAILED DESCRIPTION OF THE PREFERRED EMBODIMENT(S)

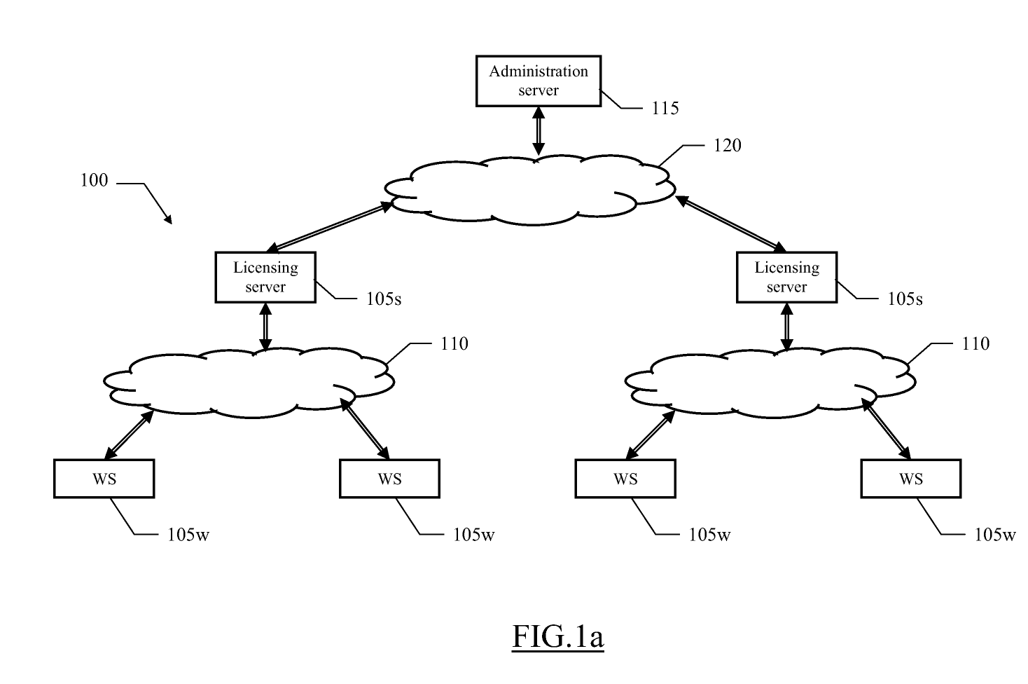

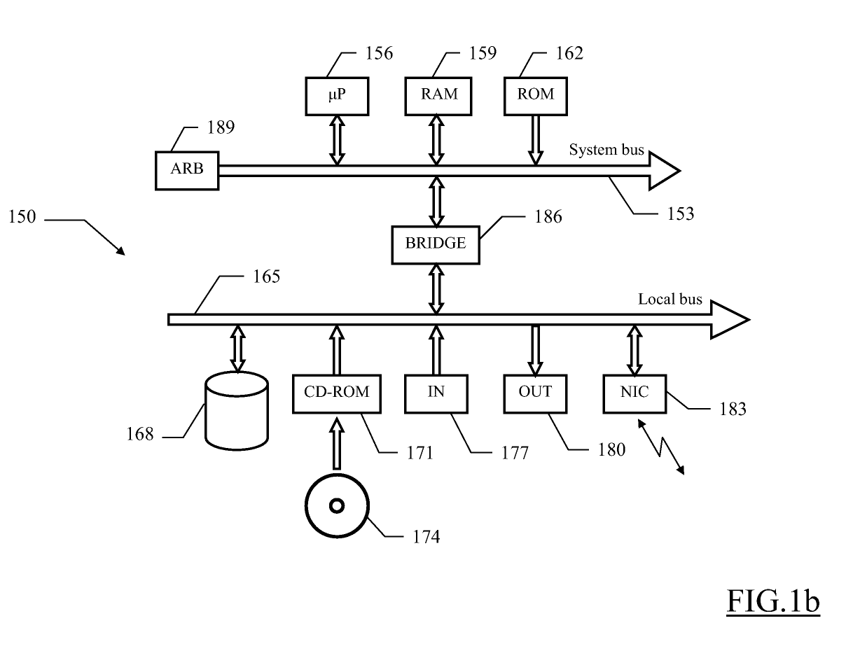

With reference in particular to FIG. 1a, a data processing system 100 with distributed architecture is depicted. The system 100 includes multiple workstations 105w, which are grouped into different sets; a licensing server 105s is associated with the workstations 105w of each set. The licensing server 105s and the corresponding workstations 105w are connected to each other through a network 110 (for example, a LAN). The different licensing servers 105s communicate with a remote administration server 115 through a different network 120 (for example, INTERNET-based); the administration server 115 implements a central repository where usage, procurement and inventory data of the system 100 is collected and managed.

As shown in FIG. 1b, a generic computer of the system (workstation, licensing server, or administration server) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces). Particularly, a mass memory consists of a hard-disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

Similar considerations apply if the system has a different topology, or it is based on other networks. Alternatively, the computers have a different structure, include equivalent units, or consist of other data processing entities (such as PDAs, mobile phones, and the like). In any case, the solution of the invention is also suitable to be used in a system wherein the control of the workstations is decentralised, or even in a stand-alone computer.

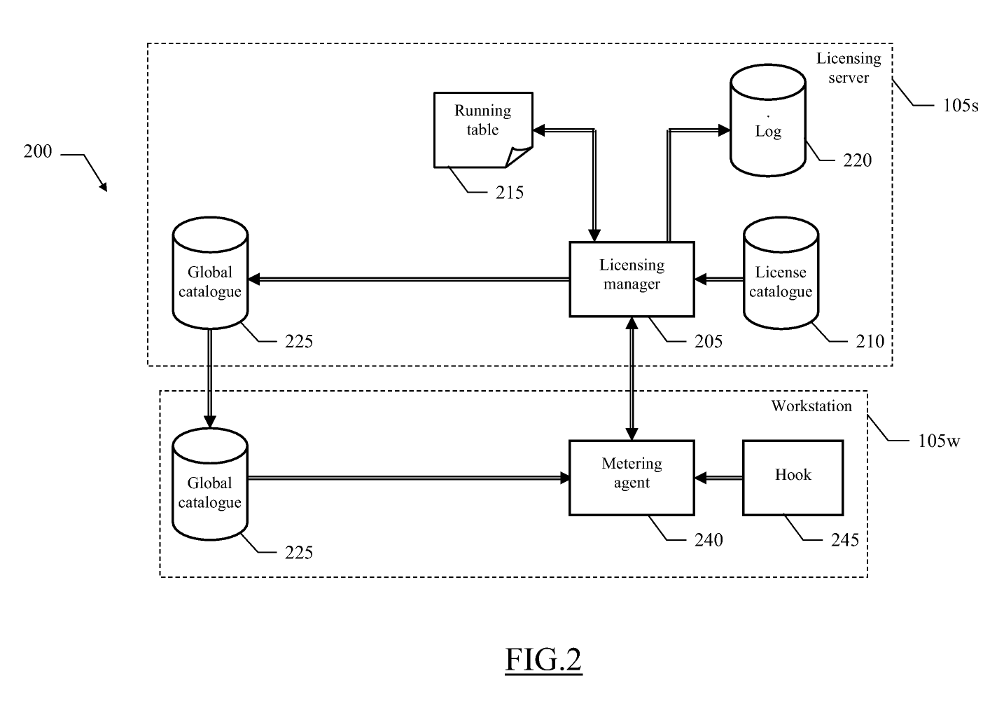

Considering now FIG. 2, the main software components that can be used to practice the method of a preferred embodiment of the invention are denoted as a whole with 200. The information (programs and data) is typically stored on the hard-disks of the different computers and loaded (at least partially) into the corresponding working memories when the programs are running.

Considering in particular a generic licensing server 105s, a corresponding manager 205 controls the associated workstations 105w (only one shown in the figure). The licensing manager 205 accesses a license catalogue 210, which contains information about the authorised conditions of use of different software products; for example, the authorisation catalogue 210 specifies the maximum processing power or the maximum capacity of the working memories of the workstations 105w on which each product can run, the number of licenses for the product (defining the maximum number of instances of the product allowed to run concurrently), and the like. Typically, more than one license is available for each product. The licensing manager 205 also controls entering of information into a running table 215, which lists the products currently in execution on the workstations 105w. In addition, the licensing manager 205 collects information from the corresponding workstations 105w (for example, about the installed programs, any attempts to run non-authorised or unknown products, and the like); this information is stored into a corresponding log 220.

The licensing server 105s also stores a global software catalogue 225, which is distributed to each workstation 105w. The global catalogue 225 lists all the known products to be metered in the system.

The global catalogue 225 is accessed by a metering agent 240 running in the background. The metering agent 240 also interfaces with a hook module 245. The hook 245 is implemented by means of a kernel extension, which adds functionality to an operating system of the workstation 105w using publicly available, standard interfaces. The hook 245 intercepts the starting of any new process on the workstation 105w, and reports the name of the corresponding executable module that has been invoked to the metering agent 240. The metering agent 240 determines the product (corresponding to the invoked executable module) that has been launched. The name of the product being launched is then transmitted to the licensing manager 205. The licensing manager 205 grants or denies the authorisation to run the product (using the license catalogue 210 and the running table 215). The result of the process is stored into the log 220 and it is returned to the metering agent 240 (updating the running table 215 if necessary); the metering agent 240 then resumes or aborts the corresponding process accordingly.

Similar considerations apply if the programs and data are structured in a different manner, if other modules or functions are provided, or if the information is stored in equivalent memory structures. In any case, the solution of the invention is also suitable to be implemented with a licensing manager that controls the authorisations to run the products directly on each workstation.

When a request for a license is received (e.g. upon detection of a product being launched on the system) the license manager 205 determines if a suitable license is available. Particularly, if a single version of a license is available on the license catalogue 210, no choice is needed and the license can be granted without any other actions. Conversely, if more than one license for the same product is available then a decision mechanism is required.

According to a preferred embodiment of the present invention we aim at providing a “good” association between software usage and licenses justifying it in the presence of complex organisational and virtualisation hierarchies, while maintaining the method general enough to support very different pricing models.

The method according to a preferred embodiment of the present invention is able to choose at each time, the best applicable license. So when an application starts, the best licenses at the time can be assigned to the application. During the lifetime of the application, the best license can change or the used license can be no longer applicable. The following are some examples:

1. a license which was in use at the time the application started, is released at a certain time, so it becomes the best available license;
2. the original license can no longer be used because it is someway changed (for example by adding additional constraints to it, like it is no longer applicable to the operating system the application is running on);
3. something changes in the hardware configuration or the organisational hierarchy, e.g.:
a. the OS hosting the application is moved from one department to another one, thus making the original license no longer applicable or making another license the best available one;
b. the HW hosting the OS where the application runs is upgraded (without stopping the application) thus making the license no longer applicable.

The ones above are simply examples of a change to the license properties, hw (i.e. resource) properties, properties of the organisation (i.e. group properties) or properties of the link between any of these entities. These changes can let another license become the best license.

Organisations are normally divided into hierarchies representing geographical or organisational structures of the enterprise. Licenses can be acquired or assigned at different levels of these hierarchies. For these reasons the hierarchies have to be taken into account when deciding which is the best license to assign to a software usage.

The system accepts the following inputs:
The method abstracts an organisation based on hierarchies: one hierarchy could be a geographical one (continent, region, state, city . . . ), while another one could be an organisational one (the development lab, the code development team, the java development department, . . . ). Basically the method accepts as an input a set of group hierarchies (where each group is one of the sample entities enumerated above). Each hierarchy has its own identifier, which allows to distinguish the groups which are part of each hierarchy. A group in a hierarchy can have a parent in the same hierarchy and can be linked (as a child) to at most one group of other hierarchies (at any point in time). The hierarchy ids generate a ranking of the hierarchies: a group in one hierarchy can be associated (as child) only to groups of hierarchies of higher rank.
Another hierarchy contains the virtualisation layers: each node is a root of such hierarchies, its child could be shared pools, LPARS, VMs, operating systems and in a future containers (like WebSphere). Each member of such hierarchies is a resource. A resource is linked to its parent resource (the roots being nodes) and can also be linked to at most one group of each group hierarchies. A resource can have one parent and be linked to one group of each hierarchy at any given point in time, meaning that at two different times it can have two different resource parents or linked groups in the same hierarchy.

Every link between resources, groups or resources and groups is tagged with a validity time interval meaning that for example the department license manager has been part of the development lab in a given period of time while has been moved for example in the research lab in a new period of time. Or an operating system has been hosted on machine A for a given period of time and then has been moved to machine B for example for an upgrade.

Each resource or group can have some properties associated. The properties depend on the ability of the licensing system to retrieve useful data about each entity: for example the number of processor of a node, the amount of memory of an operating system, the number of employees in a department. These properties are collected because some pricing model could potentially require them for computing how much a license has been used (for example IBM IPLA licenses require capacity information at each level of the virtualisation hierarchy to compute software usage).
Another input of the algorithm is the set of users known to the licensing system. These users are the ones installing or executing software and can also be used to limit license consumption only to a subset of the enterprise employees. Each user can be tagged with additional properties, describing any attribute of the user the licensing system is able to retrieve and which can be useful to some pricing model for license computation.
Still another input is a set of licenses, each one associated to one pricing model supported by the licensing system. Each license could be potentially divided into multiple distributions, i.e. divisions of the license entitlement, each one associated to different subjects allowed to use the license. Each distribution has a set of targets allowed to use this distribution (being them groups or resources) and for each of these targets one or more association validity intervals are provided (meaning that the targets are allowed to use the license only in these time intervals). Also each distribution could be associated to all the users or a subset of them (thus limiting the users which can use it). Again each of these associations are augmented with one or more time intervals, detailing the association validity.

Possible kind of licenses are e.g.:

### 1. A license usable to any employee in the Development lab (the target is the group representing the Development lab, while there are no user limitations)

2. A license usable to any employee in Italy (the target is the group representing the geographical location Italy. There are no user limitations)

### 3. A license usable only on a particular hardware system (like on a particular PC). The target is the resource representing the particular hardware, while there are no user limitations

4. A license usable only by a named user. The target is the whole enterprise, but there is a user limitation, associating the license only to one user.

Each license and distribution has associated properties which are values entered by the user when defining the license and the distribution and required by the pricing model associated to the licenses for computing license usage and compliance. Examples of these are the number of processors the licenses is licensed to; or multiple numbers for licenses like tier licenses, where each number is for a different hardware tier and so on.

One of the limitations of the current methods is that they do not distinguish between targets defined by the vendors as part of the terms and conditions (like mainframe licenses allowing software usage on agreed on machines) or defined by the user for accounting purposes (like a license paid by a department and thus targeted only to that department). In the first case usage of the software on machines where it is not licensed is a violation of the license terms and conditions and thus it is a legal exposure. In the second case if the product is licensed for ten units and nine are used inside of the target department and one outside of it, the customer has no legal exposure because it is still inside of the terms and conditions imposed by the vendor; he has only an internal accounting problem because a user is using a license his department has not paid for.

To support this additional scenario each license (or pricing model in an alternative embodiment) has a flag indicating if its distribution (the distribution of its licenses) is imposed by the software vendor or is simply for accounting purposes. As a final input one of the distribution of each license can be flagged as a default distribution, meaning it is the distribution that will be associated to usage for products associated to the license but not included in the license targets.

For warranting a good association of usage to licenses, the licensing system supports the concept of non consuming licenses: a license (or pricing model) can be flagged as not consuming if the user has to pay for the license independent of the amount of software usage. For example a site license for Product Foo for Development Lab could be a good example of non consuming license: the lab pays for the license when acquiring it and once paid it can use Product Foo as often as desired without the need to pay additional fees and without risking to overuse the license. If such a license is available for a product it has to be considered as a preferred license because use can be associated to it without risking overuse or the need to pay additional fees (like in pay per use licenses).

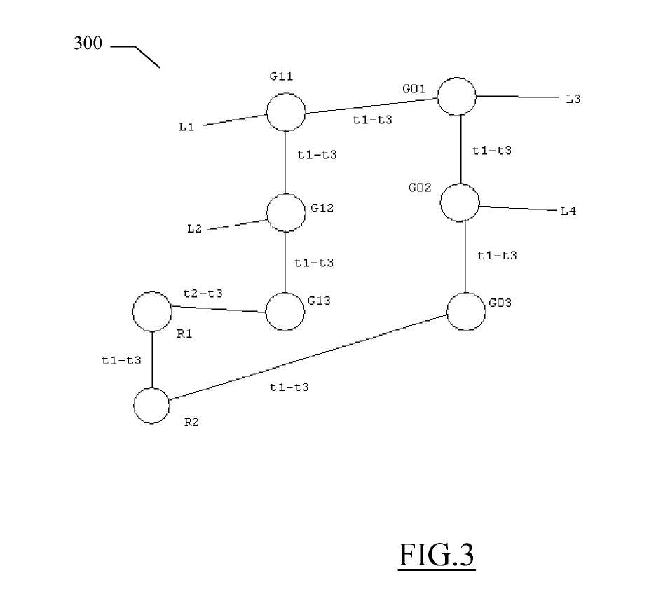

Referring now to FIG. 3, the algorithm, for each consume session, executes the following steps:

1. Navigate the resource and group hierarchies (300), starting from the resource which originated the software usage, extracting the set of license distribution reachable from that resource in each time interval and associated to the product generating the consume session:

The order in which the nodes are visited searching for a suitable license is the following one: R2, R1, G13, G12, G11, G03, G02, G01.

It means that the resource hierarchy is the first one to be visited. The parent of each resource is visited after the resource itself. In case of multiple parents they can be visited in time order (but this is not strictly required for the correctness of the algorithm). While visiting the resources the algorithms collect the list of groups reachable from each resource. In this case from R2 G03 can be reached and from R1 G13 can be reached. After completing the visit of the resource hierarchy the algorithm moves to the group hierarchies starting from the ones with lower rank (i.e. highest id). So while G03 has been found to be reachable before G13, considering that G13 has an highest id, after completing the visit of the resource hierarchy the algorithm moves to the group hierarchy with id 1, so starts from G13 and visits all the groups reachable from G13. At the end of the hierarchy 1 visit the algorithm will still have to visit the nodes G03. So because there are still nodes to visit and they are all part of the same hierarchy, the visit continues visiting node G03 and all the nodes reachable from it (G02, G01).

During the visit a reachable time interval is always maintained. So R2 is always reachable in the consume session interval (t1, t3). Also R1 is always reachable in the interval (t1,t3), while G13 is reachable in the intervals (t2,t3).

Searching for licenses the first found for product P1 along the sequence described above is the license L2 with validity time (t2,t3) and then L4 with validity time (t1,t3).

2. Select the validity time of each license based on user limits. If the license (or distribution) has no user limits, it can be associated to the consume session at any time. Otherwise the license (or distribution) cannot be associated in the time periods where the consume session user is not associated to the license (or distribution). If for example L2 is associated to the user U1 in the time interval (t1,t2), then L2 cannot be used for the use session because target limits are satisfied in the interval (t2,t3) and user limits are satisfied only in (t1,t2).

This step can be performed also before step 1.

3. For all the licenses (or distributions) which can be associated to the consume session, ask the pricing model if the session can really be assigned and in what time intervals. There are some pricing models imposing additional constraints on consume sessions to be associated, e.g. a reference pricing model which allows a consume session to be associated to a license (or distribution) only if the product referenced by P1 is also installed on the machine, otherwise the license cannot be used. So the association is possible only during the time intervals where also the referenced product is installed on the machine.
4. Once the algorithm has obtained the list of licenses associable to a consume session with the related time intervals, the algorithm prefers non-consuming licenses. So if L1 is non-consuming, the session is assigned to L1 even if L2 is reached before.
5. If no valid license is found, based on the target constraints, the algorithm searches for licenses (or distributions) marked as “default” and reachable from the root of all the hierarchies (G01) with the time interval for reach ability. The nearest license (or distribution) associated to the product originating the consume session is considered as the first one valid for the association.
6. If more than two licenses (or distributions) are obtained for a given time interval (because two of them are associated to the same resource or group) the algorithm prefers installation licenses (or distributions) to usage ones. If there are two installation or usage licenses (or distributions) the algorithm orders them according to the license id and distribution id and selects one according to the id of the resource generating the usage (but it could be based also on the user id or any combination of both of them or any property of the consume session).

The above method allows to handle complex organisational structures and virtualisation hierarchies by preferring non consuming licenses to consuming ones thus optimising the license association. It also allows to include license model specific constraints in the association processing, thus supporting different pricing models and their constraints. It can be extended also to product hierarchies by considering all the licenses associated not to the product originating the consume session but to all the products in the hierarchy of the consuming one.

The method of ordering the preferred licenses according to a mix of their distance from the consuming resource and the relative order of hierarchies, is just one of several possibilities. One alternative could be to combine all the attributes, maybe with a relative weight and calculating a global “preference value” for each license.

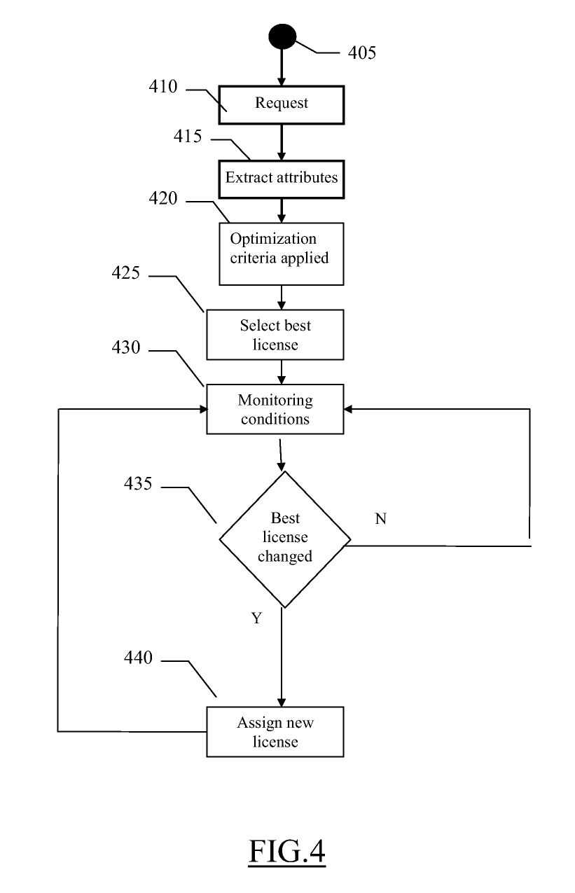

Considering now FIG. 4, the logic flow of a metering process according to an embodiment of the invention is represented with a method 400. The method begins at the black start circle 405. Continuing to block 410, a request is received by the licensing manager 205. The request is normally triggered by the detection of the start of a new process as explained above.

The method passes to block 415, wherein the attributes are extracted from the license catalogue 210. At block 420 all available licenses are ordered according to predetermined optimisation criteria (e.g. saving the more flexible licenses for future uses as disclosed in U.S. patent application Ser. No. 11/181,404). At block 425 the best available license is selected and assigned to the application use. Block 430 monitors if any of the conditions influencing the predetermined optimisation above has changed. In such case it is checked (at step 435) if a better license according to such criteria could be identified. If yes (step 440) a new license is assigned to the application for use.

Similar considerations apply if the method includes equivalent or additional steps.

Alternatively, the list of parameters can be customised according to user selection or can be based on other conditions. In the same way the optimisation criteria can be defined by different expressions, even using more complex logical operators. Also the determination if a license is suitable for the requested use or not could be done before the evaluation and sorting of the parameters.

Although not described in detail in order to avoid obscuring the description of the invention with unnecessary details, it is obvious that a procedure is also provided for notifying the licensing manager when the execution of a product is terminated (so as to update the table of available licenses). In addition, it is possible to have each workstation send a heartbeat message to the licensing manager periodically (for example, every ten minutes); in this way, the products running on the workstation can be deleted from the running table (in order to release the respective licenses) if the heartbeat message is not received within a predefined period (meaning that the workstation is not working correctly). Moreover, the administration server periodically collects the information logged on the different licensing servers, in order to create different reports (for example, relating to the installation and/or usage of the products on the workstations).

Although the invention has been described above with a certain degree of particularity with reference to preferred embodiment(s) thereof, it should be understood that various changes in the form and details as well as other embodiments are possible. Particularly, it is expressly intended that all combinations of those elements and/or method steps that substantially perform the same function in the same way to achieve the same results are within the scope of the invention.

For example, the use of the proposed solution in a context different than the licensing management is contemplated. Particularly, the information that has been detected about the products can be used for reporting or inventory purposes only (without any verification of their authorisations). Also it is to be noted that the term “use” when referred to a software product may include the simple installation or loading of the product in the system memory.

In any case, the method of the invention can be used to meter any kind of software products (such as a video games, multimedia works, and the like); moreover, the launch of the products can be detected in another way (for example, periodically collecting a list of the executable modules that are running).

In addition, the programs can be distributed on any other computer readable medium (such as one or more DVDs); alternatively, the programs are pre-loaded onto the hard-disks, are transmitted to the computers, are broadcast, or more generally are provided in any other form directly loadable into the working memories of the computers.

Moreover, it will be apparent to those skilled in the art that the additional features providing further advantages are not essential for carrying out the invention, and may be omitted or replaced with different features.

In any case, the method according to the present invention is also suitable to be carried out with a hardware structure (for example, integrated in a chip of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims.

1. A method of metering usage of at least one software product on a data processing system, the at least one software product having a plurality of available associated licenses, each license having a set of attributes, the method including the steps of:
detecting an event indicative of the use of the at least one product on the system, and
responsive to the detection, determining the best available license among said plurality of licenses, according to predetermined preference rules of the attributes,
applying metering conditions to the at least one software product according to the identified best available license;
detecting a change of the best available license and applying new metering conditions to the at least one software product accordingly.

2. The method of claim 1 wherein the step of detecting includes the steps of:
monitoring the processing system for detecting events which modify at least one of the attributes;
responsive to the modification, repeating the step of identifying the best available license and, if necessary, applying new metering conditions to the at least one software product.

3. The method according to claim 2, wherein the attributes are indicative of usage constraints of the product.

4. The method according to claim 1, wherein the at least one product has a set of usage requirements and the step of determining includes the steps of:
creating for each product an ordered list of the available licenses according to the preference rules;
scanning the list until a suitable license having all the parameters matching the product usage requirements, is found.

5. The method according to claim 4, wherein the available licenses are ordered according to at least one hierarchy and the scanning of the list follows the at least one hierarchy.

6. The method of claim 5 including a plurality of ordered hierarchies and wherein the licenses belonging to each hierarchy are scanned only after the licenses belonging to the preceding hierarchy have been scanned.

7. The method of claim 1 wherein the step of determining includes determining which of the plurality of licenses has the highest usage constraint.

8. The method according to claim 7 wherein the set of parameters includes the license expiration date.

9. A computer program in a computer readable medium for metering usage of a least one software product on a data processing system into a working memory of a data processing system for performing a method when the program is run on the system. The method including the steps of:
detecting an event indicative of the use of the at least one product on the system, and
responsive to the detection, determining the best available license among said plurality of licenses, according to predetermined preference rules of the attributes,
applying metering conditions to the at least one software product according to the identified best available license; and
detecting a change of the best available license and applying new metering conditions to the at least one software product accordingly.

10. An apparatus for metering usage of software products on a data processing system, wherein at least one software product has a plurality of available associated licenses, each licenses having a set of attributes the apparatus comprising:
means for detecting an event indicative of the use of the at least one product on the system;
means for responsive to the detection determining the best available license among said plurality of licenses, according to predetermined preference rules of the attributes;
means for applying metering conditions to the at least one software product according to the identified best available license; and
means for detecting a change of the best available license and applying new metering conditions to the at least one software product accordingly.
